(19) United States
(12) Patent Application Publication
(10) Pub. No.: US 2019/0010061 A1
(43) Pub. Date: Jan. 10, 2019

(54) TREATED WATER INDICATING SYSTEM AND METHOD

(71) Applicant: Richard Arthur MAYER, Reno, NV (US)

(72) Inventor: Richard Arthur MAYER, Reno, NV (US)

(21) Appl. No.: 15/860,614

(22) Filed: Jan. 2, 2018

Related U.S. Application Data
(60) Provisional application No. 62/441,533, filed on Jan. 2, 2017.

(51) Int. Cl. C02F 1/00; C02F 1/461; B01D 35/143; G08B 5/22

(52) U.S. Cl. CPC C02F 1/008; C02F 1/003; C02F 1/4618; C02F 2209/07; G08B 5/22; C02F 2307/06; C02F 2209/005; B01D 35/143

(57) ABSTRACT

A treated water indicating system and method are described. The water indicating system includes a water treatment unit and a tap. The water treatment unit receives water. The tap includes an indicator light. The indicator light is configured to produce a visible indication of a state of the water treatment unit, in which the indicator light operates in a first mode to produce a visible indication that the water treatment unit is in a first state producing acidic water. Additionally, the indicator light operates in a second mode to produce a visible indication that the water treatment unit is in a second state producing ionized alkaline water. Furthermore, the indicator light operates in a third mode to produce a visible indication that the water treatment unit is in a third state producing ionized purified water. The tap is configured to be coupled to the water treatment unit.

### REFERENCE TO RELATED APPLICATIONS

This application claims the benefit of provisional patent application number 62/441,533, entitled “TREATED WATER INDICATING SYSTEM AND METHOD” filed on Jan. 2, 2017.

### FIELD

The presently disclosed subject matter relates to a treated water indicating system and method. More particularly, the disclosed subject matter relates to a water dispensing system and method that displays various states of water treatment using an indicator light at the tap.

### BACKGROUND

Water treatment units are known in the art frequently as either countertop units or under-the-counter units. Countertop units are free standing or mounted at a kitchen countertop surface or similar stable location near a kitchen sink, water basin, washbasin, or equivalent. Such countertop water treatment units are incongruous with cabinetry and kitchen decor, reduce available countertop space, and add noise to the local environment (e.g., kitchen). However, countertop units are conveniently accessible near the water dispensing location and readily indicate to the user the type of water being produced and dispensed. Because of the detrimental characteristics, though, owners, operators, and users often desire to place, store, or mount water treatment units out of sight and hearing from the water dispensing location, such as under the counter or at a remote location to maintain the congruity of the decor and reduce noise pollution at the water dispensing location.

Under-the-counter water treatment units solve the problems of incongruity, reduced countertop space, and noise by enclosing water treatment units within a cabinet or other storage area, or removing the water treatment unit to a remote location, such as another room within a house or outside of a building. However, this solution creates other inconveniences unique to under-the-counter water treatment units. Under-the-counter water treatment units having remote control or remote indication capabilities are not known in the art. The absence of remote control or remote indication capabilities in existing water treatment units require users to suffer the previously discussed inconvenience of a countertop water treatment unit or to employ a remote water treatment unit requiring the user to open cabinetry or retreat to a remote location to control the state of the water treatment unit and to determine the type of water (e.g., purified, carbonated, alkaline, acidic, or untreated) being produced and dispensed. Additionally, in this configuration, audible system alerts (such as audible status warnings and indicators) may be muted by the water treatment unit enclosure, and a user dispensing water from the water treatment unit may fail to observe the audible and visible alerts generated by the water treatment unit.

It would be beneficial to provide a system and method for dispensing water from a water treatment unit capable of remote control and remote indication, while freeing countertop space for daily use and insulating the operator from the noise and unsightly incongruity of a countertop treatment unit.

### SUMMARY

A treated water indicating system and method is described herein. The system includes a water treatment unit and a tap. The water treatment unit is configured to receive water. The tap includes an indicator light. The indicator light is configured to produce a visible indication of a state of the water treatment unit. The tap is coupled to a countertop and to the water treatment unit. The tap is disposed at a water basin.

In one embodiment, the water treatment unit includes a water ionizer. In another embodiment, the tap includes a treated water spout. In a further illustrative embodiment, the tap includes a waste water spout.

In another embodiment, the water treatment unit includes a control panel that indicates the state of the water treatment unit. Additionally, the control panel changes the state of the water treatment unit. The control panel is further configured to receive a user input that changes the input state of the water treatment unit.

In yet another embodiment, the tap is electrically connected to the water treatment unit. The electrical connection provides the tap with power and an information signal.

In a further embodiment, the water treatment unit has at least three states that includes a first state producing acidic water, a second state producing alkaline water, and a third state producing source water. In a still further embodiment, the indicator light operates in a first mode to produce a visible indication that the water treatment unit is in a first state producing acidic water. Also, The indicator light may operate in a second mode to produce a visible indication that the water treatment unit is in a first state producing acidic wash cycle water. Additionally, the indicator light may operates in a second mode to produce a visible indication that the water treatment unit is in a second state producing ionized alkaline water. Furthermore, the indicator light may operate in a third mode to produce a visible indication that the water treatment unit is in a third state producing ionized purified water.

Another treated water indicating system is also described, which includes a water treatment unit and a tap. The system includes a water treatment unit configured to receive water. The tap includes an indicator light. The indicator light is configured to produce a visible indication of a state of the water treatment unit, in which the indicator light operates in a first mode to produce a visible indication that the water treatment unit is in a first state producing acidic water. Additionally, the indicator light operates in a second mode to produce a visible indication that the water treatment unit is in a second state producing ionized alkaline water. Furthermore, the indicator light operates in a third mode to produce a visible indication that the water treatment unit is in a third state producing ionized purified water. The tap is configured to be coupled to the water treatment unit.

A treated water indicating method is also described. The method includes generating a treated water with a water treatment unit. The method transfers the treated water to a tap. The tap includes an indicator light that produces a visible indication of a state of the water treatment unit. The method proceeds to dispense the treated water with the tap. The method indicates the state of the water treatment unit with the indicator light.

In one embodiment, the treated water is one of acidic water, acidic wash cycle water, ionized alkaline water, and ionized purified water. The indicator light operates in a plurality of modes to indicate the state of the water treatment unit.

In an illustrative embodiment, the indicator light operates in a first mode to produce a visible indication that the water treatment unit is in a first state producing acidic water, a second mode to produce a visible indication that the water treatment unit is in a second state producing ionized alkaline water, and a third mode to produce a visible indication that the water treatment unit is in a third state producing ionized purified water.

In another illustrative embodiment, the tap further includes an ionized water spout and a waste water spout. In yet another illustrative embodiment, the tap further includes a volume control valve. In a still further embodiment, the water treatment unit is a water ionizer.

In an even further embodiment, the water treatment unit includes a control panel that indicates the state of the water treatment unit. Additionally, the control panel changes the state of the water treatment unit. The control panel is further configured to receive a user input that changes the input state of the water treatment unit.

### DRAWINGS

FIG. 1 shows an illustrative embodiment of the water treatment unit and tap installed in an under-the-counter configuration, with the tap disposed at a water basin.

FIG. 2A shows a cross-sectional view of a mounted tap.

FIG. 2B shows an illustrative view of a tap configured to be coupled to the water treatment unit and mounted on a countertop as described herein and in accordance with various embodiments.

FIG. 3 shows a view of the printed circuit board (PCB) attached to the under-side of the tap.

FIG. 4 shows an illustrative water treatment unit from the front and the water filter assembly.

FIG. 5 shows an illustrative water treatment unit from the rear and the inner water filter cover removed for display, with the inner water filter exposed.

FIG. 6 shows an illustrative water treatment unit from the rear with the inner water filter cover exposed.

FIG. 7 shows an illustrative water treatment unit from the rear with the outer water filter cover in place and on display.

FIGS. 8A and 8B show an illustrative water treatment unit control panel.

FIG. 9 shows an illustrative water treatment unit control panel display.

FIG. 10 shows a flow chart for a method of dispensing treated water from a water treatment unit having a variety of states.

FIG. 11 shows a flow chart for a method of installing a water dispensing system capable of dispensing treated water at a tap and indicating at the tap the state of the water treatment unit.

### DESCRIPTION

Persons of ordinary skill in the art will realize that the following description is illustrative and not in any way limiting. Other embodiments of the claimed subject matter will readily suggest themselves to such skilled persons having the benefit of this disclosure. It shall be appreciated by those of ordinary skill in the art that the systems and methods described herein may vary as to configuration and as to details. Additionally, the methods may vary as to details, order of the actions, or other variations without departing from the illustrative methods disclosed herein.

A system and method for dispensing a variety of types of water at a tap are described. The water indicating system and method includes an indicator light and the tap is coupled to a water unit as described herein. The water treatment unit and tap described herein have been adapted for installation in or near a structure, such as a residence, having a water basin. The water treatment unit and tap provide a variety of types of water for drinking, cooking, cleansing, and other associated purposes. Additionally, the water treatment unit and tap provide users with remote indication of the state of the water treatment unit and the ability to remotely control the state of the water treatment unit.

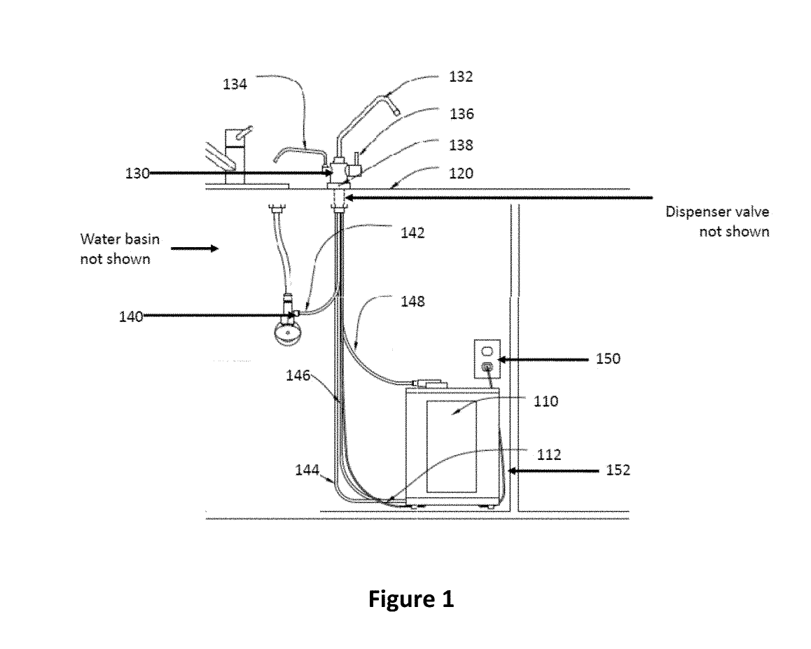

Referring now to FIG. 1, there is shown a water treatment unit 110 installed under a countertop 120, and a tap 130 mounted on the countertop 120 at a water basin (not shown). The tap 130 includes a treated water spout 132, a waste water spout 134, a volume control valve 136, an indicator light 138, and a dispenser valve (not shown). The tap 130 receives source water through a source water hose 142 coupled to a water source 140. The water treatment unit 110 receives source water through a second source water hose 144. The water treatment unit 110 provides waste water to the tap 130 through a waste water hose 146 and provides treated water to the tap 130 through a treated water hose 148. The water treatment unit 110 is electrically coupled to the tap 130 through power and signal wires 112. A power source 150 delivers power to the water treatment unit 110 via a power cord 152.

The water treatment unit 110 may function, as described herein, to produce (depending upon the state selected) alkaline water, acidic water, source water, or purified water. In all states, water may return from the water treatment unit 110 to the tap 130 for dispensing at the treated water spout 132. For example, alkaline water produced by the water treatment unit 110 may be channeled from the water treatment unit 110 to the tap 130 through the treated water hose 148. Similarly, acidic water may be channeled from the water treatment unit 110 to the tap 130 through the waste water hose 146. Similarly, purified water may be channeled from the water treatment unit 110 to the tap 130 by way of the treated water hose 148. The tap 130 may thus dispense alkaline, acidic water, source water, or purified water at the water tap 130 depending upon the type (alkaline, acidic, purified, source) of water received from the water treatment unit 110.

The water treatment unit 110 treats source water from, for example: city mains, building mains, wells, or an equivalent source of water. Therefore, source water for the water treatment unit 110 may be tap water, well water, city water, or an equivalent type of water. The source water may vary as to the quality, pH level, Total Dissolved Solids (TDS), and temperature.

In one embodiment, the water treatment unit 110 is a water ionizer capable of producing at least three types of treated water, including: alkaline water, acidic water, and purified water. The water treatment unit 110 comprises a plurality of water filters that initially filter source water, an electrolysis component, and an outer housing surrounding the electrolysis component. The electrolysis component includes a plurality of electrolysis plates. The outer housing also encloses the filter assembly and the control panel components (e.g., a microcontroller or circuit board). A source water hose 144, waste water hose 146, and treated water hose 148 pass through the outer housing to connect to the electrolysis component. A power cord 152 also passes through the outer housing to a power distribution assembly, which provides power to the electrolysis component and the control panel 800. The control panel 800 and control panel display 810 are disposed on one face of the outer housing. In this embodiment, the indicator light 138 operates in a first mode to produce a visible indication that the water treatment unit 110 is in a first state, producing acidic water, in a second mode to produce a visible indication that the water treatment unit is in a second state, producing alkaline water, in a third mode to produce a visible indication that the water treatment unit is in a third state, dispensing source water, and in a fourth mode to produce a visible indication that the water treatment unit is in a fourth state, producing purified water.

In addition, source water may pass through one or more of the plurality of water filters prior to entering the electrolysis component and/or as the water is transferred to the tap 130. Further, in various embodiments, water may be filtered at both stages; that is, water may be filtered prior to electrolysis at the plurality of electrolysis plates, and as the water exits the water treatment unit 110.

The electrolysis plates may be titanium covered by platinum or the electrolysis plates may comprise another suitable noble metal (e.g., gold, silver, and palladium) covering non-noble corrosion resistant metals or materials.

In another embodiment, the water treatment unit 110 is a water purifier, a deionizer, or a reverse osmosis unit capable of producing at least three types of treated water, including: deionized water, purified water, and source water. The deionized water may be channeled from the water treatment unit 110 to the tap 130 by way of a deionized water input tube. The purified water may be channeled from the water treatment unit 110 to the tap 130 by way of a purified water input tube. In these embodiments the indicator light 138 operates in a first mode to produce a visible indication that the water treatment unit 110 is in a cleaning state, in a second mode to produce a visible indication that the water treatment unit 110 is in a second state, producing deionized water, in a third mode to produce a visible indication that the water treatment unit 110 is in a third state, producing purified water, in a fourth mode to produce a visible indication that the water treatment unit 110 is in a fourth state, dispensing source water, in a fifth mode to produce a visible indication that the water treatment unit 110 is in an idle state, and in a sixth mode to produce a visible indication that the water treatment unit 110 requires attention.

In still other embodiments the water treatment unit 110 is a water enhancer capable of producing at least one type of treated water (carbonated water) and capable of dispensing at least two types of water, including: carbonated water and source water. The carbonated water may be channeled from the water treatment unit 110 to the tap 130 by way of a carbonated water input tube. In these embodiments the indicator light 138 operates in a first mode to produce a visible indication that the water treatment unit 110 is in a cleansing state, in a second mode to produce a visible indication that the water treatment unit 110 is in a second state, producing carbonated water, in a third mode to produce a visible indication that the water treatment unit 110 is in a third state, dispensing source water, in a fourth mode to produce a visible indication that the water treatment unit 110 is in an idle state, and in a fifth mode to produce a visible indication that the water treatment unit 110 requires attention.

In various embodiments, the water treatment unit 110 may be located, for convenience, under a countertop (known in the art as under-the-counter units), within a cabinet, or some other location remote from the water basin or dispensing tap. The dispensing tap may be a tap, faucet, or equivalent situated at, near, or within a water basin, washbasin, or sink.

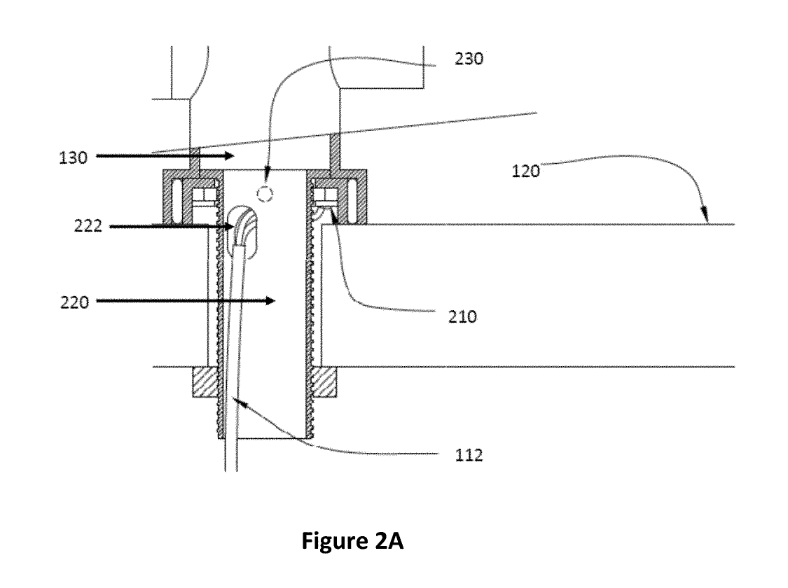

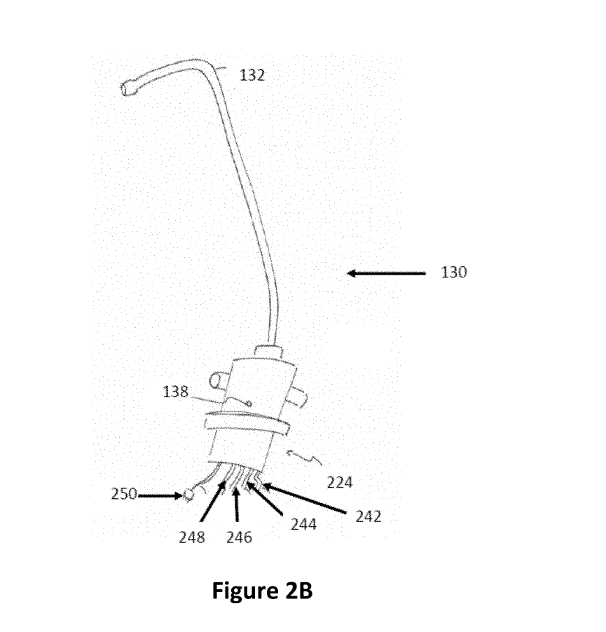

Referring now to FIG. 2A, there is shown a cross-sectional view of the tap 130 mounted on the countertop 120 at a water basin (not shown). A printed circuit board (PCB) 210 is attached to the under-side of the tap 130 and is electrically coupled to the water treatment unit (not shown) via power and signal wires 112. The power and signal wires 112 run through an aperture 222 in a tap mount housing 220. The tap mount housing 220 extends through the countertop 120 and houses the dispenser valve (not shown). An indicator light lens 230 is disposed in the tap mount housing 220. The indicator light 138 produces a visible indication of a state of the water treatment unit 110, which is visible through the indicator light lens 230.

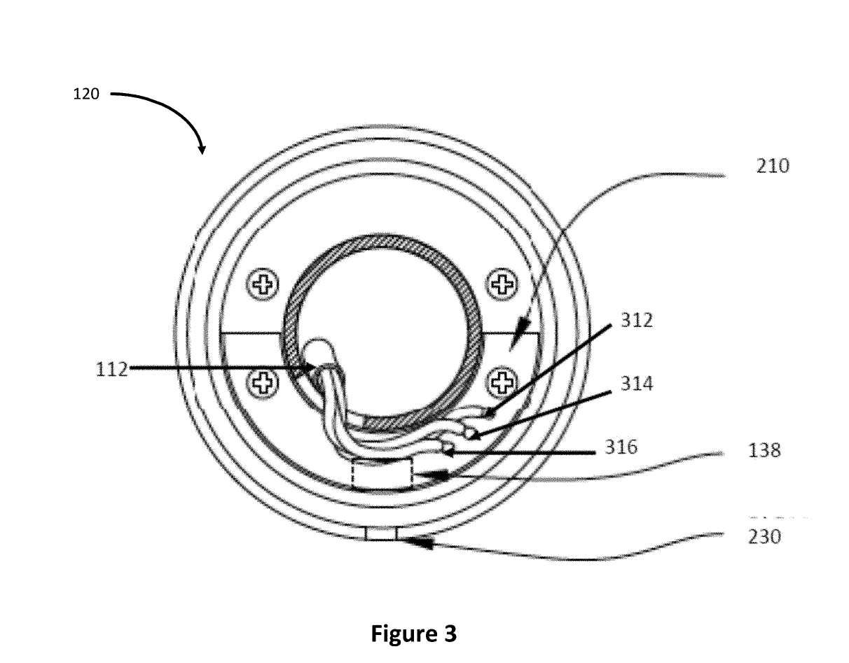

Referring now to FIG. 3, there is shown a view of the PCB 210 attached to the under-side of the tap 130. Wire leads 312, 314, and 316 couple the power and signal wires 112 to the PCB 210. The indicator light 138 is not visible and is located above the PCB 210.

In operation, the water treatment unit 110 may transmit data, such as an instruction, to the PCB 210 of the tap 130. The data may describe the water producing state of the water treatment unit 110 or, for example, the type (or pH) of water being generated by the water treatment unit 110. The PCB 210 may receive and interpret the data and may communicate (via wire leads 312, 314, and 316 or wirelessly) with the indicator light 138 to output a particular color or pattern of light, including, but not limited to, white, red, blue, green, yellow, blinking, constant, and any combination thereof. For example, the PCB 210 may cause the indicator light 138 to generate a red output light when the water treatment unit 110 is in a first state generating acidic water, a blue blinking output light when the water treatment unit 110 is in a second state generating alkaline water, and a blue constant output light when the water treatment unit 110 is in a third state generating purified water. The PCB 210 may further cause the indicator light 138 to generate other colors and/or flash to denote other operational states of the water treatment unit 110 (e.g., the indicator light 138 may be configured to flash red when the water treatment unit is in a cleaning state).

Referring now to FIG. 2B, there is shown an alternative embodiment, wherein the tap 130 may include a water spout 132 and a tap body 224. The tap body 224 may include a dispenser valve (not shown), a source water input tube 242 for receiving source water from the water source 140 through the source water hose 142, a source water output tube 244 for transferring source water to the water treatment unit 110 through the second source water hose 144, an alkaline water input tube 246 for receiving alkaline water from the water treatment unit 110 when the water treatment unit 110 is in the second water producing state, an acidic water input tube 248 for receiving acidic water from the water treatment unit 110 when the water treatment unit is in a first water producing state, a control cable 250 configured to connect to the power and signal wires 112, a microcontroller or control board (such as a printed circuit board or PCB) 210 capable of executing instructions received from the water treatment unit 110, and an indicator light 138.

In one embodiment, the tap 130 further includes a selector (not shown) capable of changing the state of the water treatment unit 110. The selector receives a user's entered instructions (such as by a button, series of buttons, or a touch screen display). In these embodiments, the tap 130 further includes a microcontroller or control board (not shown) that is capable of relaying instructions entered by the user at the tap 130 to the water treatment unit 110 via a controller (not shown) disposed at the water treatment unit 110. The indicator light 138 operates in the mode entered by the user at the selector (not shown).

The indicator light 138 may therefore flash, change color, or otherwise produce a visible indication for the user of an alert, warning, or the state of the water treatment unit 110. For instance, and as described above, the indicator light 138 may operate in a first mode (such as providing constant red light) to indicate that the water treatment unit 110 is in a cleansing state and should not be used until the cleansing is complete. The indicator light 138 may also operate in a second mode to indicate that the water treatment unit 110 is in a second state producing alkaline water, a third mode to indicate that the water treatment unit 110 is in a third state dispensing source water, and a fourth mode to indicate that the water treatment unit 110 is in a fourth state producing purified water. The indicator light may further operate in a fifth mode to indicate an idle state or a ready state of the water treatment unit 110. The indicator light may also operate in another mode to indicate that the water treatment unit 110 requires attention (e.g. filter change, electrolysis plate descaling, salt addition, or otherwise performance of an operating or maintenance task incapable of performance by the water treatment unit 110).

When the water treatment unit 110 is in the second state, producing alkaline water and the fourth state, producing purified water, the waste water spout 134 dispenses source water. When the water treatment unit 110 is in the acid wash cycle, the waste water spout 134 dispenses acidic wash cycle water.

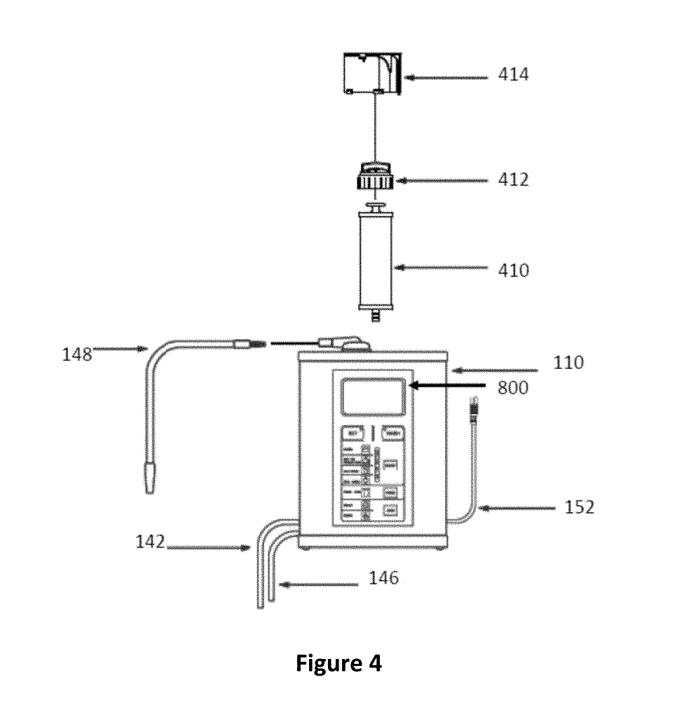

Referring now to FIG. 4, there is shown the water treatment unit 110 from the front and detached from the dispenser valve (not shown) and water source 140. A power cord 152 couples the water treatment unit 110 to a power source 150 (e.g., 110V, 115V, 120V, 220V, 230V, and 240V AC power supplies). The water treatment unit 110 includes a water filter 410, shown removed from the water treatment unit 110 and disconnected from an inner water filter cover 412, and an outer water filter cover 414, shown detached from the water treatment unit 110. A control panel 800 occupies the front-side of the water treatment unit 110.

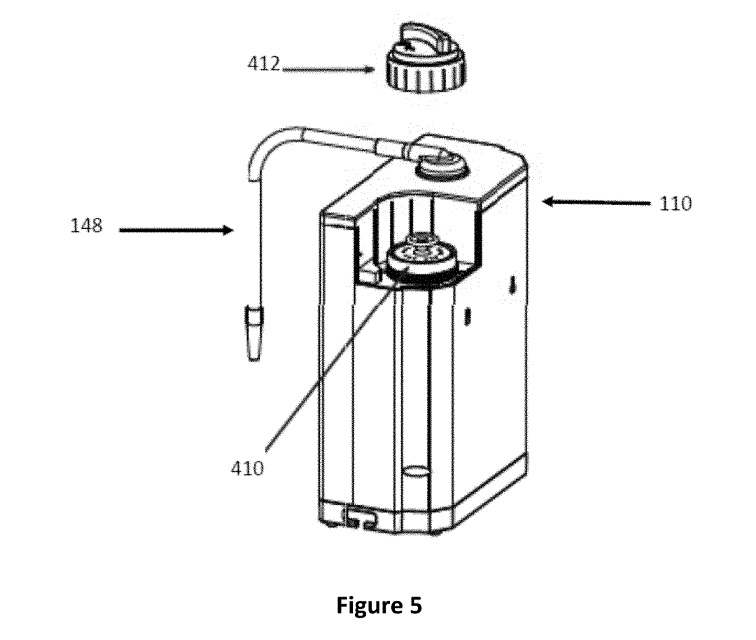

Referring now to FIG. 5, there is shown the water treatment unit 110 from the rear and detached from the dispenser valve (not shown). The inner water filter cover 412 is shown removed, revealing the water filter 410 installed within the water treatment unit 110.

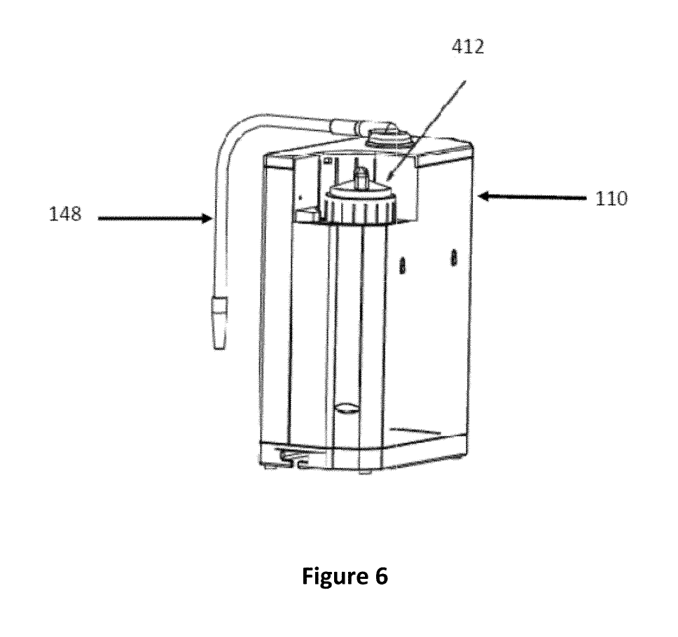

Referring now to FIG. 6, there is shown the water treatment unit 110 from the rear and detached from the dispenser valve (not shown). The inner filter cover 412 is shown installed in the water treatment unit 110, covering the water filter 410.

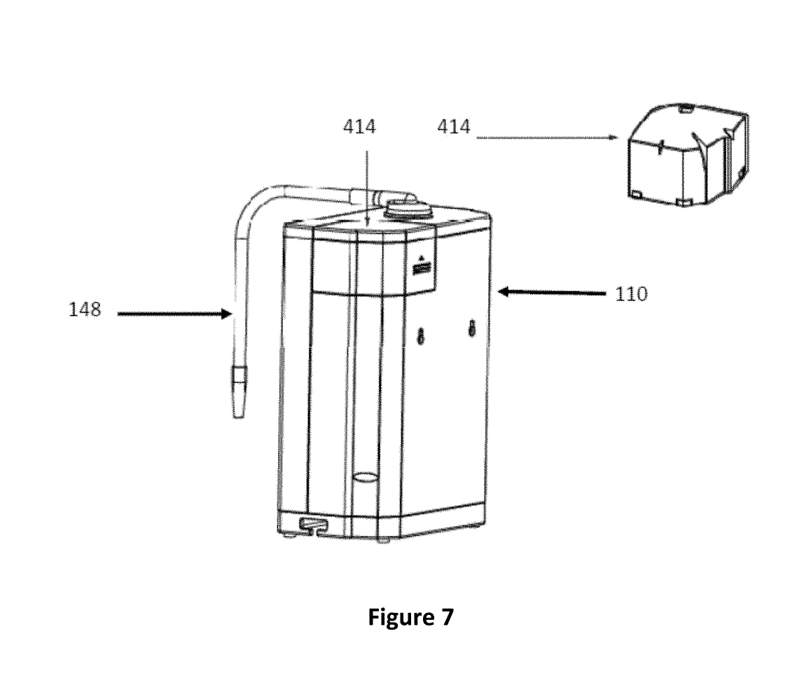

Referring now to FIG. 7, there is shown the water treatment unit 110 from the rear and detached from the dispenser valve (not shown). The outer filter cover 414 is shown both as installed on the water treatment unit 110, and detached from the water treatment unit 414. When installed, the outer filter cover 414 covers, protects, and encloses the water filter 410 installed in the water treatment unit 110.

The water filter 410 may be a carbon water filter, such as a tube, assembly, or array of activated carbon particles. The water filter 410 may also be a membrane filter. In one embodiment, the membrane filter is an antimicrobial membrane filter having pores of a diameter sufficient to filter microbes and bacteria (e.g., between 0.1 μm and 10 μm).

The water filter 410 is disposed within the outer housing of the water treatment unit 110, such that the outer filter cover 414 and the inner filter cover 412 may be removed and the water filter 410 may then be removed for cleaning or replacement.

In various embodiments, the water filter 410 may be a plurality of water filters comprising a first sediment filter, a second sediment filter, a carbon filter, a first pathogens filter, and a second pathogens filter (none shown). The sediment filters may filter sediment and mineral content from source water. The carbon filter may filter mineral and other content from the water, and the first and second pathogens filters may filter various pathogens (such as bacteria and other microbial organisms) from the water. Water may pass through the filters in any sequence. For example, water may flow through the first and second sediment filters, then through the carbon filter, and finally through the first pathogens filter and the second pathogens filter. A final sediment, carbon, and/or pathogens filtration stage may be added to ensure water quality.

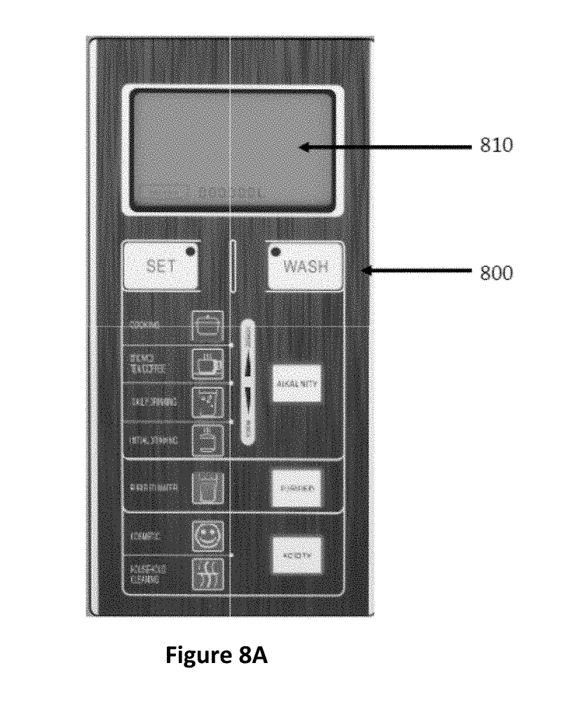

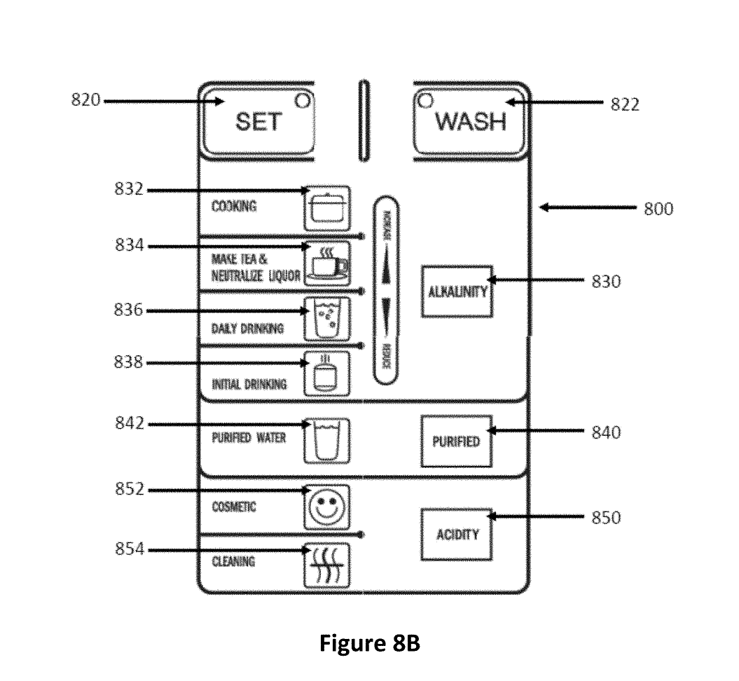

Referring now to FIG. 8A, there is shown an illustrative control panel 800 and control panel display 810. The control panel display 810 exhibits a variety of information relating to the state and operation of the water treatment unit 110, as discussed below in detail. The control panel 800 includes several selectors (e.g., electrical: an icon, a clickable image, or an equivalent; or mechanical: a switch, a button, or an equivalent) capable of receiving user input (e.g., by pressing, touching, flipping, or an equivalent user input) to change the state of the water treatment unit 110. Computer readable memory (not shown) and a processor (not shown) are communicatively coupled to both the control panel 800 and control panel display 810.

Referring now to FIG. 8B, there is shown an illustrative control panel 800 in the absence of the control panel display 810. The control panel 800 includes a SET selector 820 and a WASH selector 822. The control panel 800 further includes an ALKALINITY selector 830, a PURIFIED selector 840, and an ACIDITY selector 850.

The SET selector 820 allows a user to confirm the state of the water treatment unit 110 selected by the user. The WASH selector 822 allows a user to select a cleansing wash cycle, which causes the water treatment unit 110 to enter a cleansing state. While in the cleansing state, the water treatment unit 110 cleanses the internal components, including the electrolysis component with acidic wash cycle water. While in the cleaning state, the water treatment unit 110 may reverse the polarity of the plurality of electrolysis plates in the electrolysis component.

In another embodiment, the SET selector 820 indicates, by illuminating, that a state of the water treatment unit 110 selected by a user is engaged and the water treatment unit 110 is dispensing the selected type of water. In this embodiment, the WASH selector 822 indicates, by illuminating, that the water treatment unit 110 has entered a cleansing state and is producing acidic wash cycle water.

The ALKALINITY selector 830 allows a user to select any one of the alkaline presets: a COOKING preset 832, a MAKE TEA & NEUTRALIZE LIQUOR preset 834, a DAILY DRINKING preset 836, and an INITIAL DRINKING preset 838. Selection of the COOKING preset 832 causes the water treatment unit 110 to enter and maintain the second state, producing alkaline water (e.g., alkaline water of a pH 9.5-11.0) preferred for cooking uses (e.g., cooking, washing food, and removing food stains) at the tap 130. Selection of the MAKE TEA & NEUTRALIZE LIQUOR preset 834 causes the water treatment unit 110 to enter and maintain the second state, producing alkaline water (e.g., alkaline water of a pH 9.5-10.0) preferred for use in tea, coffee, and to neutralize ingested alcohol at the tap 130. Selection of the DAILY DRINKING preset 836 causes the water treatment unit 110 to enter and maintain the second state, producing alkaline water (e.g., alkaline water of a pH 8.5-9.5) preferred for user ingestion (e.g., for drinking throughout the day, morning, evening, and night) at the tap 130. Selection of the INITIAL DRINKING preset 838 causes the water treatment unit 110 to enter and maintain the second state, producing alkaline water (e.g., alkaline water of a pH 7.5-8.5) preferred for initial user ingestion (e.g., first drink(s)) at the tap 130.

The PURIFIED selector 840 allows a user to select the PURIFIED preset 842. Selection of the PURIFIED preset 842 causes the water treatment unit 110 to enter and maintain a fourth state producing purified water (e.g. for user ingestion) at the tap 130.

The ACIDITY selector 850 allows a user to select any one of the COSMETIC preset 852 and the CLEANING preset 854. Selection of the COSMETIC preset 852 causes the water treatment unit 110 to enter and maintain the first state, producing acidic water (e.g., acidic water of a pH 6.5-5.0) preferred for cosmetic uses (e.g., facial cleansing, hair cleansing, skin exfoliation, and acne treatment) at the tap 130. Selection of the CLEANING preset 854 causes the water treatment unit 110 to enter and maintain the first state, producing acidic water (e.g., acidic water of a pH 3.5-5.0) preferred for cleaning purposes (e.g., household cleaning and disinfecting) at the tap 130.

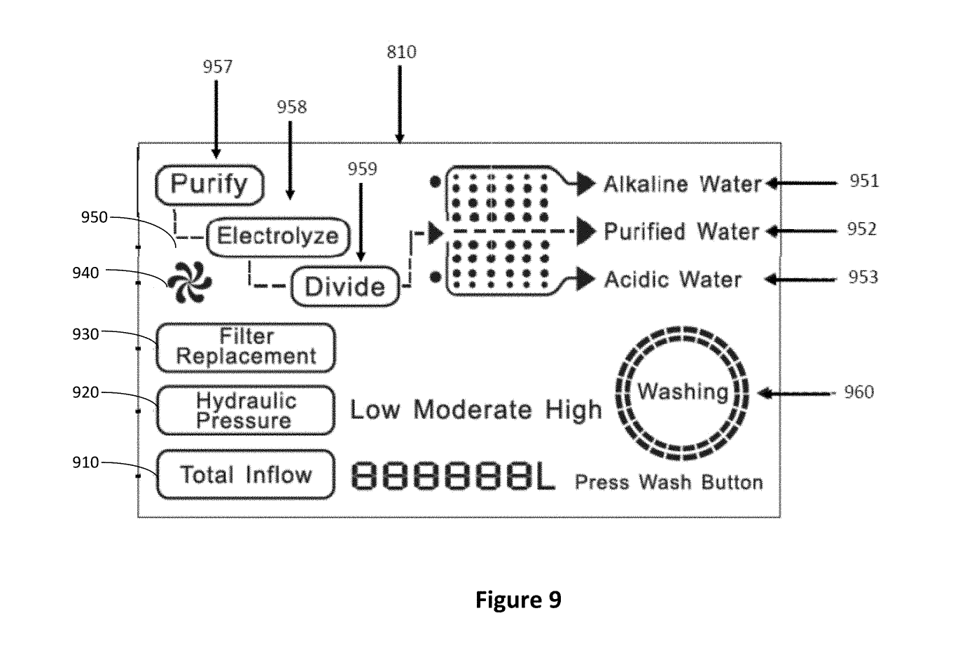

Referring now to FIG. 9, there is shown the control panel display 810 in operation. The control panel display 810 features a Total Inflow Monitor 910, a Water Pressure Indicator 920, a Filter Replacement Alert 930, a Water Flow Indicator 940, a Water Production Monitor 950, and a Washing Flasher 960. The control panel display 810 further includes Water Production Monitor Indicators, including an Alkaline Water Indicator 951, a Purified Water Indicator 952, and an Acidic Water Indicator 953. The Total Inflow Monitor 910 displays the total commutative water flow through the water treatment unit 110. The Water Pressure Indicator 920 indicates whether water pressure is Low, Moderate, or High. The Filter Replacement Alert 930 advises the user to replace the water filter 410. The Water Flow Indicator 940 indicates the presence or absence of source water flowing to the water treatment unit 110. The Water Flow Indicator 940 may perform a visible animation (e.g., rotating) to indicate the presence of source water flowing to the water treatment unit 110. The Washing Flasher 960 indicates that the water treatment unit 110 is in an automatic cleansing state. The water treatment unit 110 enters the automatic cleansing state without requiring a user selection. For example, the water treatment unit 110 may enter the automatic cleansing state when the water treatment unit 110 ceases water production of any one of the alkaline and acidic presets.

The Water Production Monitor 950 displays the stage of water production of the water treatment unit 110. The stages of production include a filtration stage indicated by a Purify indicator 957, an electrolysis stage indicated by an Electrolyze indicator 958, and a separation stage indicated by a Divide indicator 959. The Water Production Monitor 950 also indicates the water producing state of the water treatment unit 110. The Alkaline Water Indicator 951 indicates that the water treatment unit 110 is in a second state producing alkaline water for dispensing at the tap 130. The Purified Water Indicator 952 indicates that the water treatment unit 110 is in a fourth state producing purified water for dispensing at the tap 130. The Acidic Water Indicator 951 indicates that the water treatment unit 110 is in a first state producing acidic water for dispensing at the tap 130 or for use by the water treatment unit 110 in a cleansing wash cycle.

In another embodiment, the water treatment unit 110 further includes a controller, such as a processor (not shown) that may be coupled to a memory having tangible, non-transitory, computer-readable instructions stored thereon that, when executed by the processor, cause the water treatment unit 110 to change its state to conform to the user's selection. The user may make such a selection at a selector disposed at the tap 130, the control panel 800, or at some other control interface.

The water treatment unit 110 may adjust based upon a manual input by a user, which may be provided to the water treatment unit 110 by way of an application interface provided on a wireless communication device that is communicatively coupled to the water treatment unit 110.

A wireless communication device (i.e., mobile communications device) may comprise a controller or processor (not shown) configured to execute instructions for a software application, which may be stored on a tangible, non-transitory, computer-readable medium or memory (not shown) of the wireless communications device. The wireless communications device may further include a variety of communications hardware for communicating with the water treatment unit 110, such as a network interface card, one or more radios (e.g., a WiFi radio system, a BLUETOOTH radio system, a cellular radio system, and the like).

The water treatment unit 110 may further power on and power off based upon a preset determination that the water treatment unit 110 requires a cleansing wash cycle. For example, the water treatment unit 110 may power on, engage in a cleansing state, and generate acidic wash cycle water.

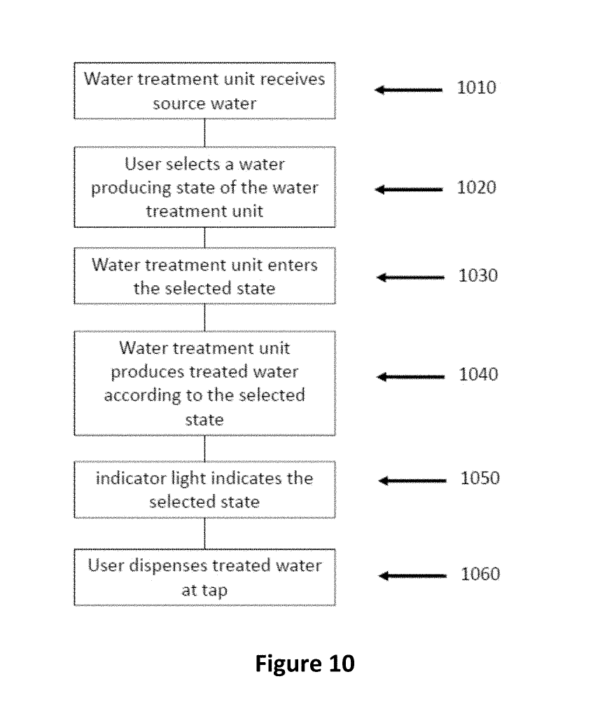

Referring now to FIG. 10, there is shown a flow chart depicting a method of operation of the water dispensing system. The water treatment unit receives source water 1010 from a water source. A user then selects a water producing state of the water treatment unit 1020, for example at the control panel. The water treatment unit then enters the state selected by the user 1030. Once in the selected state, the water treatment unit proceeds to produce the type of water associated with the selected state 1040. When the water treatment unit enters the state selected by the user, the indicator light operates in a mode associated with the selected state to visibly indicate at the tap the type of water being produced by the water treatment unit. The user may then dispense the selected type of water from the tap confident that the water treatment unit is producing a desired type of water.

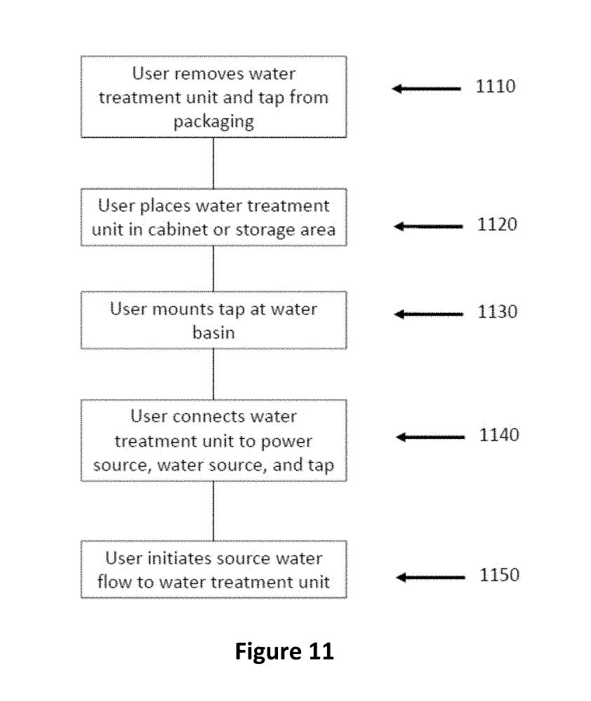

Referring now to FIG. 11, there is shown a flow chart depicting an exemplary method of installing the water dispensing system disclosed herein. The user removes the water treatment unit and tap from their associated and or respective packaging 1110. The user then places the water treatment unit in a cabinet, storage area, adjacent room, or other remote location and affixes the water treatment unit to its location or enclosure as necessary 1120. The user mounts the tap at a water basin, kitchen sink, washbasin, or equivalent 1130. The user then connects the water treatment unit to a power source (e.g., wall outlet), a water source (e.g., building main), and the mounted tap 1140. Last, the user initiates a flow of source water to the water treatment unit, such as by opening a valve at the water source 1150.

It is to be understood that the detailed description of illustrative embodiments is provided for illustrative purposes. The scope of the claims is not limited to these specific embodiments or examples. Therefore, various process limitations, elements, details, and uses can differed from those just described, or be expanded on or implemented using technologies not yet commercially viable, and yet still be within the inventive concepts of the present disclosure. The scope of the invention is determined by the following claims and their legal equivalents.

What is claimed is:

1. A treated water indicating system, the system comprising:
a water treatment unit configured to receive water;
a tap including an indicator light, the indicator light is configured to produce a visible indication of a state of the water treatment unit; and
wherein the tap being coupled to a countertop, coupled to the water treatment unit.

2. The system of claim 1 wherein the water treatment unit is a water ionizer.

3. The system of claim 1 wherein the water treatment unit includes a control panel configured to indicate the state of the water treatment unit;
the control panel further configured to change the state of the water treatment unit; and
the control panel is further configured to receive a user input that changes an input state for the water treatment unit.

4. The system of claim 1 wherein the tap further includes a treated water spout.

5. The system of claim 4 wherein the tap further includes a waste water spout.

6. The system of claim 1 wherein the tap is electrically connected to the water treatment unit, the electrical connection providing the tap with power and an information signal.

7. The system of claim 1 wherein the water treatment unit has at least three states that includes a first state producing acidic water, a second state producing alkaline water, and a third state producing source water.

8. The system of claim 1 wherein the indicator light operates in a first mode to produce a visible indication that the water treatment unit is in a first state producing acidic water.

9. The system of claim 8 wherein the indicator light operates in a second mode to produce a visible indication that the water treatment unit is in a first state producing acidic wash cycle water.

10. The system of claim 8 wherein the indicator light operates in a second mode to produce a visible indication that the water treatment unit is in a second state producing ionized alkaline water.

11. The system of claim 10 wherein the indicator light operates in a third mode to produce a visible indication that the water treatment unit is in a third state producing ionized purified water.

12. A treated water indicating system, the system comprising:
a water treatment unit configured to receive water;
a tap including an indicator light, the indicator light is configured to produce a visible indication of a state of the water treatment unit, in which the indicator light operates in a first mode to produce a visible indication that the water treatment unit is in a first state producing acidic water;
wherein the indicator light operates in a second mode to produce a visible indication that the water treatment unit is in a second state producing ionized alkaline water;
wherein the indicator light operates in a third mode to produce a visible indication that the water treatment unit is in a third state producing ionized purified water; and
wherein the tap is configured to be coupled to the water treatment unit.

13. A treated water indicating method comprising:
generating a treated water with a water treatment unit;
transferring the treated water to a tap disposed, the tap including an indicator light, in which the indicator light is configured to produce a visible indication of a state of the water treatment unit;
dispensing the treated water with the tap; and
indicating the state of the water treatment unit with the indicator light.

14. The method of claim 13 wherein the treated water is one of acidic water, acidic wash cycle water, ionized alkaline water, and ionized purified water.

15. The method of claim 13 wherein the indicator light operates in a plurality of modes to indicate the state of the water treatment unit.

16. The method of claim 13 wherein the indicator light operates in a first mode to produce a visible indication that the water treatment unit is in a first state producing acidic water, a second mode to produce a visible indication that the water treatment unit is in a second state producing ionized alkaline water, and a third mode to produce a visible indication that the water treatment unit is in a third state producing ionized purified water.

17. The method of claim 13, wherein the tap further includes an ionized water spout and a waste water spout.

18. The method of claim 16, wherein the tap further includes a volume control valve.

19. The method of claim 13, wherein the water treatment unit is a water ionizer.

20. The system of claim 13 wherein the water treatment unit includes a control panel configured to indicate the state of the water treatment unit;
the control panel further configured to change the state of the water treatment unit; and
the control panel is further configured to receive a user input that changes an input state for the water treatment unit.
